(19) United States
(12) Patent Application Publication
(10) Pub. No.: US 2013/0257484 A1
(43) Pub. Date: Oct. 3, 2013

(54) VOLTAGE-TO-CURRENT CONVERTER

(71) Applicant: MEDIATEK SINGAPORE PTE. LTD., Singapore (SG)

(72) Inventors: Hamid RAFATI, Atherton, CA (US); Bryan Liangchin HUANG, Los Altos, CA (US); Meng-Hung CHEN, Cupertino, CA (US)

(73) Assignee: MEDIATEK SINGAPORE PTE. LTD., Singapore (SG)

(21) Appl. No.: 13/621,765

(22) Filed: Sep. 17, 2012

Related U.S. Application Data
(60) Provisional application No. 61/617,722, filed on Mar. 30, 2012.

(51) Int. Cl. H02M 11/00

(52) U.S. Cl. CPC H02M 11/00
USPC 327/103

(57) ABSTRACT

A voltage-to-current converter is described. In one embodiment, the voltage-to-current converter includes an operational amplifier, where a first input of the operational amplifier is coupled to a first node and a second input of the operational amplifier is coupled to a reference voltage. The input voltage is connected to the first node through a resistor which generates the input current. The voltage-to-current converter also includes a first transistor coupled to a first node and to an output of the operational amplifier, where the input current flows through the first transistor. The voltage-to-current converter also includes a second transistor coupled to the first transistor, to the output of the operational amplifier, and to an output node, where an output current flows through the second transistor. The first and second transistors constitute a current mirror to provide additional current gain for the output current.

### CROSS-REFERENCE TO RELATED APPLICATION

This application claims benefit under 35 USC 119(e) of U.S. Provisional Patent Application No. 61/617,722, filed on Mar. 30, 2012, entitled “VOLTAGE-TO-CURRENT CONVERTER,” which is incorporated herein by reference in its entirety.

### FIELD OF THE INVENTION

The present invention relates generally to electronic circuits, and more particularly to a voltage-to-current converter.

### BACKGROUND

A voltage-to-current converter provides a current from a voltage source. A transistor such as a metal-oxide-semiconductor field-effect transistor (MOSFET) may be used to provide a simple voltage-to-current converter. For example, an input voltage at the gate of a transistor generates an output current through the transistor. Such a voltage-to-current converter provides plenty of voltage headroom (i.e., voltage supply-output voltage), but the output current is a nonlinear function of the input voltage for large input swings. The output current can be linearized by a degeneration resistor, but at the expense of voltage headroom. Operational amplifiers may be used in a voltage-to-current converter, but operational amplifiers could limit the maximum input swing and degrade linearity.

Accordingly, what is desired is an improved circuit for converting voltage to current. The circuit should be easily implemented, cost effective, reliable, and should be adaptable to existing communications systems. Embodiments described herein address such a need.

### SUMMARY

A voltage-to-current converter is described. In one aspect, the voltage-to-current converter includes an operational amplifier, where one input of the operational amplifier is connected to the input voltage through a resistor, and the second input of the operational amplifier is connected to a reference voltage. The voltage-to-current converter also includes a first transistor to carry the input current generated. The voltage-to-current converter also includes a second transistor coupled to the first transistor, where an output current flows through and amplifies the input current.

### BRIEF DESCRIPTION OF THE DRAWINGS

FIG. 1 is a block diagram of a voltage-to-current converter in accordance with one embodiment of the present invention.

### DETAILED DESCRIPTION

The present invention relates generally to electronic circuits, and more particularly to a voltage-to-current converter. The following description is presented to enable one of ordinary skill in the art to make and use embodiments of the invention, and is provided in the context of a patent application and its requirements. Various modifications to the embodiments and the generic principles and features described herein will be readily apparent to those skilled in the art. Thus, embodiments of the present invention are not intended to be limited to the examples shown, but are to be accorded the widest scope consistent with the principles and features described herein.

Embodiments provide a voltage-to-current converter. In one aspect, the voltage-to-current converter includes an operational amplifier, where a first input of the operational amplifier is coupled to a reference voltage Vref. The operational amplifier copies the reference voltage to the node Vx which is ideally Vref and fixed. The input current is generated through the resistor R connected between Vin and Vx. The input current is ideally (Vin−Vref)/R which is a linear representation of the input voltage, Vin. The voltage-to-current converter also includes a first transistor, where the input current flows, coupled to node Vx and to an output of the operational amplifier. The voltage-to-current converter also includes a second transistor coupled to the first transistor, to the output of the operational amplifier, and to an output node, where an output current flows through. In one embodiment, an input common mode voltage at the voltage input node and an output common mode voltage at the output node are decoupled from each other, which independently maximizes the input and output voltage swings.

As described in more detail below, the voltage-to-current converter provides independent input and output common mode voltages, which improves input voltage swings and output swings. The voltage-to-current converter also simultaneously improves linearity and gain and provides low supply-voltage operation.

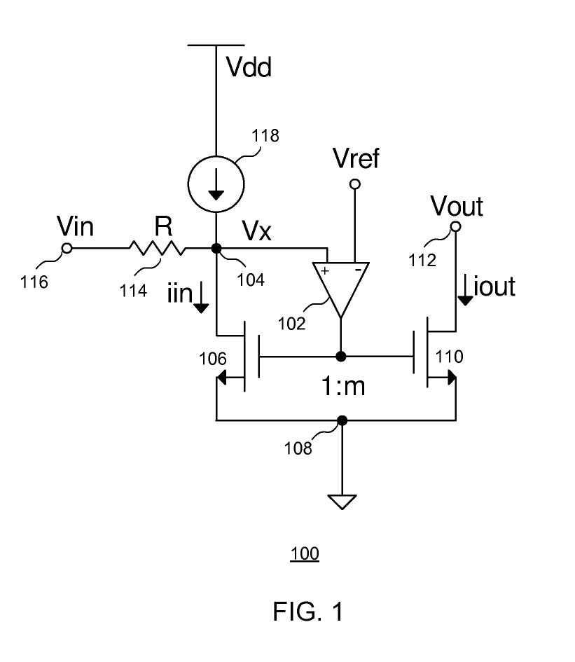

FIG. 1 is a block diagram of a voltage-to-current converter 100 in accordance with one embodiment of the present invention. As shown, the voltage-to-current converter 100 includes an operational amplifier 102. The operational amplifier has an input that coupled to a node Vx, or node 104, and has another input coupled to a reference voltage Vref.

The voltage-to-current converter 100 also includes a transistor 106. In one embodiment the transistor 106 is a MOSFET. In one embodiment, the transistor 106 has a drain node that is coupled to the node 104. The transistor 106 has a source node that is coupled to a ground node 108. The transistor 106 has a gate node that is coupled to the output of the operational amplifier 102. An input current iᵢₙ flows through the transistor 106.

The voltage-to-current converter 100 also includes a transistor 110. In one embodiment the transistor 110 is a MOSFET. In one embodiment, the transistor 110 has a drain node that is coupled to an output node 112. The common mode voltage of the output voltage Vout is set independently at the output node 112. The transistor 110 has a source node that is coupled to the ground node 108. The transistor 110 has a gate node that is coupled to the output of the operational amplifier 102 and coupled to the gate of the transistor 106. An output current iₒᵤₜ flows through the transistor 110.

In one embodiment, the transistor 106 and the transistor 110 are sized to minimize headroom penalty. In one embodiment, the transistor 106 and the transistor 110 constitute a current mirror. In one embodiment, the current mirror provides a gain of the output current iₒᵤₜ to the input current iᵢₙ. The voltage-to-current converter 100 achieves additional gain with improved linearity through the current mirror at no voltage-headroom penalty.

In one embodiment, the voltage-to-current converter 100 also includes a resistor 114. The resistor 114 is coupled between a voltage input node 116 and the node 104. The voltage input node 116 is coupled to an input voltage Vin. The node 104 is coupled to current source 118, which is coupled to a voltage supply Vdd. In one embodiment, the current source 118 provides part of the DC current for transistor 106. In other words, the DC current flowing through the transistor 106 might be not totally provided from the current source 118, for example, while the input voltage Vin and the voltage of node Vx are at different DC levels. The input current iᵢₙ is proportional to 1/R, where R is a resistance value of the resistor 114.

In one embodiment, the voltage at the node 104 is set to the reference voltage Vref, which is fixed. This causes the input current iᵢₙ to be proportional to 1/R, which improves the linearity.

In one embodiment, an input common mode voltage at the voltage input node 116, and an output common mode voltage at the output node 112 are decoupled from each other. This independently maximizes the input and output swings. In one embodiment, an input common mode voltage at the voltage input node 116 is supported by the reference voltage Vref and a DC current through the resistor 114. In one embodiment, the output common mode voltage is set independently at the output node 112. This enables the voltage swing at the operational amplifier input coupled to the node 104 to be minimized while enabling the voltage swing at the output of the operational amplifier to be maximized.

In one embodiment, the voltage-to-current converter 100 also provides a linear voltage-to-current conversion, where the converted current in the voltage-to-current converter 100 is related to the input voltage Vin by the expression: iₒᵤₜ=i_{bias}+Gm*Vin, where iₒᵤₜ an output current, i_{bias} is a bias current, and Gm is a transconductance.

In one embodiment, with respect to linearity, the transconductance Gm provided by voltage-to-current converter 100 does not depend on Vin. In one embodiment, the voltage-to-current converter 100 also provides low supply-voltage operation. Also, the voltage-to-current converter 100 maximizes the input voltage swing (e.g., max Vdd/2) and the output voltage swing (e.g., iₒᵤₜ*Rₒᵤₜ).

Embodiments disclosed herein provide numerous benefits. Implementations of the embodiments described herein provide simultaneous improvements to linearity, gain, input swing, output swing, and low supply-voltage operation. For example, embodiments described provide linear voltage-to-current conversion in contrast to conventional systems that provide an output current that is a nonlinear function of the input voltage. Some conventional systems provide an output current can be linearized but at the expense of voltage headroom. Embodiments described herein provide both linear voltage-to-current conversion and ample headroom. Embodiments described herein also decouple the input common mode voltage at the input node from the output common mode voltage at the output node, which independently maximizes the input and output voltage swings, in contrast to conventional systems that limit the input and output swing and degrade linearity.

A voltage-to-current converter has been disclosed. In one aspect, the voltage-to-current converter includes an operational amplifier, where a first input of the operational amplifier is coupled to a node Vx and a second input is coupled to a reference voltage. The voltage-to-current converter also includes a first transistor coupled to a first node and to an output of the operational amplifier, where an input current flows through the first transistor. The voltage-to-current converter also includes a second transistor coupled to the first transistor, to the output of the operational amplifier, and to an output node, where an output current flows through the second transistor.

Embodiments described herein may be utilized in various types of devices such, as but not limited to, computers, tablets, cell phones, and the like.

Although the present invention has been described in accordance with the embodiments shown, one of ordinary skill in the art will readily recognize that there could be variations to the embodiments, and those variations would be within the spirit and scope of the present invention. Accordingly, many modifications may be made by one of ordinary skill in the art without departing from the spirit and scope of the appended claims.

What is claimed is:

1. A voltage-to-current converter circuit comprising:
an operational amplifier, wherein a first input of the operational amplifier is coupled to a first node and a second input of the operational amplifier is coupled to a reference voltage;
a resistor coupled between an input node and the first node, wherein the resistor linearly converts an input voltage to an input current;
a first transistor coupled to the first node and to an output of the operational amplifier, wherein the input current flows through the first transistor; and
a second transistor coupled to the first transistor, to the output of the operational amplifier, and to an output node, wherein an output current flows through the second transistor, and wherein the first and second transistors constitute a current mirror.

2. The converter circuit of claim 1, wherein the current mirror is arranged to provide a current gain with improved linearity.

3. The converter circuit of claim 2, wherein the first and second transistors are sized to minimize headroom penalty.

4. The converter circuit of claim 1, wherein an output common mode voltage is set independently at the output node.

5. The converter circuit of claim 1, wherein an input common mode voltage is set independently at the input node.

6. The converter circuit of claim 1, wherein a voltage swing at the first input of the operational amplifier is minimized to improve the linearity of the converter circuit.

7. The converter circuit of claim 1, wherein an input common mode voltage at the input node and an output common mode voltage at the output node are decoupled from each other.

8. The converter circuit of claim 7, wherein a voltage at the first node is set by the reference voltage, allowing independent input common mode voltage at the input node.

9. The converter circuit of claim 1, wherein a gain of the output current to the input current is provided by the current mirror.

10. The converter circuit of claim 9, wherein the input current generated is proportional to 1/R, and wherein R is a resistance value of the resistor.
